(19) United States
(12) Patent Application Publication
(10) Pub. No.: US 2024/0229993 A1
(43) Pub. Date: Jul. 11, 2024

(54) MULTIMEDIA-COMPATIBLE ROTARY UNION

(71) Applicant: DEUBLIN GMBH, Mainz (DE)

(72) Inventors: Marco Kiefer, Wiesbaden (DE); Eberhard Grimm, Wiesbaden (DE); Marcel Skipas, Wiesbaden (DE)

(21) Appl. No.: 18/559,283

(22) PCT Filed: Apr. 26, 2022
(86) PCT No.: PCT/EP2022/061117

§ 371 Date: Nov. 6, 2023

(30) Foreign Application Priority Data
May 5, 2021 (DE) 102021111688.0
May 5, 2021 (DE) 102021111690.2
Dec. 3, 2021 (DE) 102021131994.3
Dec. 3, 2021 (DE) 102021131995.1

(51) Int. Cl. F16L 27/08

(52) U.S. Cl. CPC F16L 27/082; F16L 27/0828

(57) ABSTRACT

A multimedia-compatible rotary union for transferring fluid media, having different viscosities, from a stationary machine part to a rotating machine part, includes a stationary housing part having a media main channel into which pressurized fluid media can be introduced, a rotor having a rotor fluid channel connected to the media main channel, a mechanical seal between the stationary housing part and the rotor having a rotor seal ring that rotates with the rotor, and a stator seal ring, wherein the stator seal ring or the rotor seal ring is fastened to an axially movable seal ring carrier, and wherein the mechanical seal defines first and second balance ratios, and a balance ratio switching device having a predefined switching threshold value for the medium pressure and configured to switch the mechanical seal from the first balance ratio to the second balance ratio when the switching threshold value is exceeded.

### CROSS REFERENCES

This application is a U.S. National Phase Application of International Application No. PCT/EP2022/061117 filed on 26 Apr. 2022, which claims priority to German Application Nos. DE 10 2021 111 688.0 and DE 10 2021 111 690.2, each filed on 5 May 2021, and DE 10 2021 131 994.3 and DE 10 2021 131 995.1, each filed on 3 Dec. 2021, the disclosures of each of which are hereby incorporated by reference herein in their entireties.

### TECHNICAL FIELD

The present disclosure relates in general to a multimedia-compatible rotary union or rotary feedthrough for transferring different fluid media, having different viscosities, from a stationary machine part to a rotating machine part, and in particular to a multimedia-compatible rotary union in which different media, in particular having very different viscosities, e.g. compressible media on the one hand and higher-viscosity incompressible media on the other hand, can be introduced selectively, in a pressurized manner, into the rotary union.

### BACKGROUND

Rotary unions are typically used for feeding fluid media into a rotating machine part, e.g. a rotating spindle of a machine tool. For this purpose, the rotary union contains a seal between stationary components and rotating components. This seal can be designed as an axial mechanical seal. Typically, in the case of an axial mechanical seal, two slide rings or sliding seal rings slide on one another, wherein one of the seal rings rotates relative to the other, coaxially to the axis of rotation, and the seal rings seal against one another, by their opposing, mutually adjoining, annular end faces, in order to seal the interior, pressurized with a fluid medium, against the atmospheric pressure in the outside region. The type of the fluid media to be transferred by means of the rotary union can vary and in particular include compressible media, such as gases, e.g. compressed air, and liquid media, such as cooling lubricants (CL), and oils, such as cutting oil or hydraulic oil. Cooling lubricant (CL) usually consists substantially of an oil-in-water emulsion and typically has a viscosity which is not very much greater than the viscosity of pure water, i.e. a relatively low viscosity. In contrast, cutting oil and hydraulic oil have a significantly higher viscosity, which can be up to 60 mm²/s (cSt) or more. A likewise known method is what is known as reduced or minimum quantity lubrication (RQL/MQL). This typically uses an aerosol in the form of an oil-gas mixture, i.e. substantially also a compressible medium.

There is a plurality of rotary unions in existence which are usually more or less optimized for one or a few particular ones of the above-mentioned fluid media, and/or for particular ranges of allowable operating parameters. Although rotary unions are also known which can be operated using different fluid media having different properties or viscosities, it has been found that these are sometimes not universal or reliable to the desired extent. For example, under certain conditions and/or in the case of some media under some circumstances, for example at high rotational speeds, these can overheat, which can lead even to destruction of the rotary union. Inter alia it has been found that some allegedly universal rotary unions may exhibit significant problems with respect to stability, for example in dry running or with compressed air, at high rotational speeds. Dry running typically refers to the rotating operation of a rotary union without pressurization with a medium.

Furthermore, conventional rotary unions may sometimes have a relatively high leakage rate in compressed-air operation, e.g. of up to 100 standard liters per minute, or more, which may also be undesirable.

In the case of some known conventional rotary unions, the response characteristic in the case of pressure and/or media change, or when opening and closing the mechanical seal, may also require improvement.

Furthermore, under some circumstances, a residual pressure may remain in some regions of the rotary union, which pressure may not be completely released and may lead to undesired operating conditions, e.g. in dry running, up to solid friction of the seal rings.

Some rotary unions use opening or closing spring elements for the mechanical seal, in order to influence the contact pressure of the seal rings against one another. This may also prove disadvantageous under certain operating conditions. For example, the spring forces are substantially constant there, and do not correlate with the medium pressure.

In the patents EP 1 744 502 B1 and EP 2 497 978 B1 by the Deublin Company, a technology is described in which the balance ratio of the mechanical seal is in a specially preselected interval, and a suitable contact pressure between the two seal rings is ensured in a wide pressure and rotational speed range. The technology by Deublin is also known among experts under the designation AutoSense®.

Overall, a plurality of the commercially available conventional rotary unions is limited to a greater or lesser extent, in various ways, in view of the entirity of the sometimes contradictory requirements placed on rotary unions, such as area of use of the operating parameters, variety with respect to the useable fluid media, stability, simplicity for the user, universality, etc.

From the applications DE 10 2021 111 688 and DE 10 2021 111 670 of the same applicant, both filed on 5 May 2021 and not previously published, which are hereby incorporated by reference, multimedia-compatible rotary unions are known which have two different balance ratios for media of different viscosities, wherein the balance ratios are controlled via different media inlet channels. For some applications, the plurality of media connections required for this may be less desirable.

### SUMMARY

The object of the present disclosure is that of providing a multimedia-compatible rotary union which is suitable for different media, in particular compressible media, e.g. compressed air, on the one hand, and incompressible media of high viscosity, e.g. cutting oil or hydraulic oil, on the other hand.

A further aspect of the object is that of providing a multimedia-compatible rotary union which has a low leakage rate during operation with different media, viscosities and pressures, and operates in a durable and low-wear manner, even at high rotational speeds.

A further aspect of the object is that of providing a multimedia-compatible rotary union which operates i) with cutting or hydraulic oil, ii) with cooling lubricant (CL), iii) with compressed air, iv) with aerosol media for reduced or minimum quantity lubrication, and also v) without media and without pressure, i.e. in dry running, in each case at high rotational speeds in a durable and low-wear manner.

A further aspect of the object is that of providing a multimedia-compatible rotary union which combines a high degree of universality (“one-for-all”) and simplicity of use for the user, and allows backward compatibility for users of conventional rotary unions.

A further aspect of the object is that of providing a rotary union which does not have the disadvantages described above, or has them only to a small degree.

According to one aspect of the present disclosure, a multimedia-compatible rotary union for transferring different fluid media, including both compressible and incompressible media, and media having different, in particular high, viscosities in the same rotary union, from a stationary machine part to a rotating machine part, is provided. The rotary union comprises a stationary housing part for installation in the stationary machine part, and a rotor for connection to the rotating machine part. The stationary housing part encloses an in particular axial media main channel with a central working space in the form of an axial or central inner stator fluid channel. The rotor, for example in the form of a hollow shaft, comprises an also in particular axial or central rotor fluid channel, wherein the fluid channels of the stationary housing part and of the rotor are permanently, i.e. also during rotation, fluidically connected to one another, in such a way that the rotor can rotate relative to the stationary housing part, optionally with a high rotational speed, and the respective pressurized medium flows, during the rotation, from the media main channel of the stationary housing part into the rotor fluid channel of the rotating rotor, in order to be conducted out of the rotor fluid channel into the connected rotating machine part. The stationary housing part can be formed in one piece or in multiple parts.

The rotary union comprises an axial mechanical seal or end-face mechanical seal between the stationary housing part and the rotor, which seals the fluidic connection between the rotor and the stationary housing part during the rotation. For this purpose, the mechanical seal comprises a slide ring or sliding seal ring that rotates together with the rotor, known as the rotor seal ring, and a non-rotating slide ring or silding seal ring, known as the stator seal ring, wherein the two seal rings seal the transition between the stationary and the rotating region of the rotary union, by means of their opposing annular sealing surfaces that rotate relative to one another. In order that the mechanical seal can open in a controlled manner, e.g. in dry running without pressure or in compressed-air operation, at least one of the two seal rings is suspended so as to be slightly axially movable. For this purpose, the seal ring is fastened to an axially movably mounted seal ring carrier, and the mechanical seal can open and close by axial movement of the seal ring carrier with the seal ring fastened thereon. From a structural perspective, it is usually easier to suspend the stator seal ring in an axially movable manner. In this case, the axially movable seal ring carrier, together with the stator seal ring fastened thereon, forms an axially movable stator seal ring assembly. The stator seal ring assembly is mounted so as to be axially displaceable in the inner fluid channel of the stationary housing part, by means of the seal ring carrier, and can preferably compensate some angular play, in order to ensure precise sealing between the adjoining sealing surfaces of the two seal rings. A stator seal ring which is axially displaceable in this way and is optionally slightly tiltable, is also referred to by experts as a floating (stator) seal ring.

In other words, in the case of a floating stator seal ring the mechanical seal comprises a seal ring assembly, which is axially movable, but non-rotating, in the stationary housing part, comprising the stator seal ring and a complementary rotor seal ring that rotates together with the rotor. The rotor seal ring can be fastened, e.g. pressed and/or adhesively bonded or otherwise fastened, for example at the end face of the rotor facing the stationary housing part.

However, it is not impossible to reverse the assembly consisting of the floating seal ring and the seal ring complementary thereto, i.e. to suspend the rotor seal ring in an axially movable manner, in order to form the rotor seal ring as a floating seal ring. In both cases, the mechanical seal can be formed having Pop-Off® functionality. The seal ring assembly consisting of the seal ring carrier and seal ring can optionally be formed in one piece.

Preferably, the axial sealing force is brought about substantially by the medium pressure (hydraulically/pneumatically). Such mechanical seals are also referred to as balanced mechanical seals. In other words, the mechanical seal is preferably a balanced mechanical seal, in which the balance ratios are selected in such a way that the mechanical seal is balanced at least largely, optionally exclusively, hydraulically or pneumatically. In the case of said mechanical seals, the axial sealing force is thus substantially set by the geometric balance ratio. Corresponding rotary unions having a balance ratio in a specific range are provided, by the applicant, with the designation Autosense®. A mechanical seal of this kind can in particular operate without opening and/or without closing springs, wherein, however, certain spring elements, which generate additional, optionally small, opening or closing forces, should in principle not be excluded.

The mechanical seal, comprising the floating seal ring, now defines at least two different balance ratios, i.e. a first and a second balance ratio, wherein the first and second balance ratio are different.

In particular, the second balance ratio is greater than the first balance ratio. Accordingly, the medium pressure in the media main channel exceeding the switching threshold value causes an increase in the balance ratio of the mechanical seal.

The rotary union further comprises an internal balance ratio switching device, which defines a predefined switching threshold value for the medium pressure, wherein the switching threshold value is not zero. The balance ratio switching device is arranged such that, in response to the medium pressure in the media main channel or of the medium introduced into the media main channel exceeding the switching threshold value, it switches the mechanical seal from the first balance ratio, i.e. triggered by the switching threshold being exceeded in the media main channel, automatically to the second balance ratio. In other words, the increase of the medium pressure in the media main channel above the switching threshold value causes the mechanical seal to switch from the first to the second balance ratio. The balance ratio switching means is accordingly actuated by the medium pressure of the medium introduced into the media main channel, and the mechanical seal switches automatically from the first to the second balance ratio when the medium pressure in the media main channel exceeds the switching threshold value.

The balance ratio switching device is accordingly controlled hydraulically or pneumatically by the medium pressure, such that the mechanical seal can be switched hydraulically or pneumatically between the first and second balance ratio. The switching from the first to the second balance ratio, or vice versa, takes place by pressurization or depressurization of the media main channel to above or below the respective threshold value. In other words, the lower first balance ratio is present when no medium pressure is applied or when the media main channel is pressurized with a medium pressure of less than or equal to the switching threshold value, preferably with a compressible medium, and the rotary union switches to the higher second balance ratio when the media main channel is pressurized with a pressure above the switching threshold value, preferably with an incompressible or liquid medium of higher viscosity.

As a result, for example in the case of compressed-air operation at a relatively low pressure, e.g. less than or equal to 10 bar, the mechanical seal can be operated with the smaller balance ratio B, wherein the balance ratio B allows for a controlled opening of the mechanical seal with controlled desired air leakage, and is therefore suitable for compressed-air operation with rotation. In the case of pressurization of the media main channel with a higher-viscosity incompressible medium, e.g. cutting oil or hydraulic oil at a higher pressure, in particular greater than 10 bar, the mechanical seal switches and the second greater balance ratio B′ becomes effective, which closes the mechanical seal with greater closing force and is thus suitable for higher-viscosity cutting oil or hydraulic oil and prevents excessive leakage.

Cutting oil can for example have a viscosity in the range from 6 mm²/s to 18 mm²/s, and hydraulic oil can have a viscosity in the range from 32 mm²/s to 46 mm²/s (40° C.), optionally even up to 60 mm²/s (40° C.). The rotary union can be operated with the second balance ratio, but also with a lower-viscosity liquid medium, e.g. cooling lubricant (CL), e.g. having a viscosity in the range from 1 mm²/s to 3 mm²/s. In this case, the rotary union can be operated both with the compressible media and with the incompressible media, at high rotational speeds in each case, e.g. up to more than or equal to 24,000 min⁻¹, without excessive heating of the seal rings. Nonetheless, the rotary union can have an acceptably low air leakage rate in compressed-air operation, and can operate in substantially leak-free manner with an incompressible or liquid medium, even of higher viscosity.

Advantageously, in compressed-air operation a small gap results between the two sealing surfaces of the seal rings (controlled opening of the mechanical seal), such that no wear occurs and a desired controlled slight air leakage escapes (AutoSense®). In contrast, in the case of the liquid media having high viscosity, such as cutting oil or hydraulic oil, the two seal rings are pressed against one another with higher force, on account of the higher balance ratio, i.e. the mechanical seal is closed, such that a gap enlargement and an undesired leakage is prevented.

Thus, in an advantageous manner, a highly universal multimedia-compatible rotary union can be provided, which is suitable for pressurization with very different media, e.g. compressible media on the one hand, e.g. compressed air, and highly viscous liquid media, e.g. cutting oil or hydraulic oil, on the other hand, and specifically has high stability at high rotational speeds, and a leakage rate in the case of all the media used, in particular is substantially leak-free in the case of liquid media.

If there is no medium pressure prevailing in the media main channel, there is no closing force on the mechanical seal. Optionally, in the state without pressure the secondary seal can pull back the floating seal ring (known as PopOff® function). As a result, in dry running there is no contact between the seal ring sealing surfaces, and temporally unlimited dry running can also take place at high rotational speeds.

Furthermore, the balance ratio switching device is arranged such that, in response to the medium pressure of the medium introduced into the media main channel falling below a predefined switch-back threshold value, it switches the mechanical seal from the second balance ratio, triggered by falling below the switch-back threshold value in the media main channel, automatically back to the first balance ratio.

The balance ratio switching device accordingly switches the mechanical seal automatically from the second back to the first balance ratio, when the medium pressure in the media main channel falls below the switch-back threshold value. In other words, the drop of the medium pressure in the media main channel below the switch-back threshold value causes the mechanical seal to switch from the second to the first balance ratio.

The switching threshold value and/or the switch-back threshold value are preferably greater than the allowable maximum pressure of the rotary union for compressed-air operation. The switching threshold value at which the mechanical seal switches from the first to the second balance ratio, and/or the switch-back threshold value, are preferably greater than 5 bar, preferably greater than 10 bar, preferably between 5 bar and 100 bar, preferably between 10 and 50 bar, preferably between 10 and 30 bar. This ensures that, in the entire allowable pressure range for compressed-air operation, only the first lower balance ratio, which allows for the controlled gap opening of the mechanical seal and thus the air leakage, is present, and not the second balance ratio.

Preferably, the switching threshold value and the switch-back threshold value are the same, such that the switching processes between the first and second balance ratio and back take place at the same medium pressure in the media main channel. They can also be selected differently, however.

The rotary union further comprises a connection port for connection of a media pressure line, in order to introduce the desired media, with a medium-specific desired medium pressure, into the media main channel. Preferably, the rotary union is a single port rotary union, i.e. has just one single connection port for connection of a media pressure line, and one single media main channel through which all the desired different media are conducted (alternately). The rotary union is thus arranged such that both compressible media, in particular compressed air, and incompressible media, in particular cutting oil or hydraulic oil, can be introduced into the same media main channel, in a pressurized manner, via the same connection port. In this case, all the media are introduced alternately (not simultaneously) via the same connection port, and the pressure increase of the currently present medium above the switching threshold value in the single media main channel causes the switching from the first to the second balance ratio, and/or the pressure drop below the switch-back threshold value of the currently present medium in the single media main channel causes the switch back from the second to the first balance ratio.

Preferably, the single connection port is a (co)axial connection port, and the media main channel is an axial media main channel which in particular extends (co)axially from the connection port to the mechanical seal. Preferably, the media main channel from the connection port to the mechanical seal is permanently open, i.e. the (co)axial media main channel itself does not contain any valves which would disturb the flow of the media from the connection port through the media main channel into the rotor fluid channel. As a result, inter alia an undesired demixing in the media main channel can be prevented, e.g. when the rotary union is operated with minimum quantity lubrication (RQL/MQL). However, a radial connection port should in principle not be excluded.

The currently desired medium and the respective medium pressure are set by the user, at a media distribution network outside of the rotary union. For this purpose, outside of the rotary union, a plurality of media sources, media supply lines, a distributor, and external valves in the media supply lines for the different media, in particular having different viscosities, in particular both at least one compressible medium and at least one incompressible medium, in particular at least compressed air and at least cutting oil or hydraulic oil, are included. The medium supply lines, in particular for compressed air and for cutting oil or hydraulic oil, are interconnected outside of the rotary union via the distributor, in order to select the medium desired in each case from outside the rotary union, by means of the external valves, in order to introduce said medium into the single media main channel, via the single connection port, with the desired medium pressure. That is to say that all the permitted media are switched on and switched off alternately, outside of the rotary union, and introduced into the rotary union alternately, i.e. in temporal succession, via the same connection port.

Upon application of a medium pressure below the switching threshold value to the media main channel, the first balance ratio of the mechanical seal has a value in the range from approximately 0.40 to 0.65, preferably in the range from approximately 0.45 to 0.60, preferably in the range from approximately 0.47 to 0.60, preferably in the range from approximately 0.50 to approximately 0.57. Upon application of a medium pressure above the switching threshold value to the media main channel, the second balance ratio of the mechanical seal has a value of greater than approximately 0.55, preferably in the range from approximately 0.60 to 1, preferably in the range from approximately 0.60 to 0.7, preferably a value of approximately 0.65+/−0.03. Preferably, the second balance ratio is greater than the first balance ratio by at least 0.1.

As has already been set out above, according to a preferred embodiment the seal ring carrier, with the stator seal ring fastened thereon, forms an axially movable seal ring assembly, and the switching from the first to the second balance ratio takes place hydraulically, by pressurization of an outside effective diameter of the seal ring carrier with the medium from the, preferably axial, media main channel.

Preferably, a branch switching channel branches off from the media main channel inside the stationary housing part, in particular radially to the axis of rotation of the rotary union, which channel leads to the balance ratio switching device, such that the medium introduced into the media main channel via the branch switching channel acts, with the respective medium pressure, on the balance ratio switching device, on the media main channel side, in order to thereby actuate the balance ratio switching device and thereby bring about switching between the first and the second balance ratio.

According to one embodiment, the seal ring carrier comprises a first axial region having a first effective diameter, and a second axial region having a second effective diameter, wherein the first effective diameter corresponds to the first balance ratio, and the second effective diameter corresponds to the second balance ratio. Furthermore, a balance ratio control channel leads to the second axial region having the second effective diameter, and the second balance ratio is brought about in that the second effective diameter of the seal ring carrier is acted on with the medium pressure from the media main channel, via the balance ratio control channel. In particular, the second effective diameter is greater than the first effective diameter, as a result of which an increase in the closing forces of the mechanical seal is brought about, when the medium pressure is applied to the second effective diameter.

The seal ring carrier is preferably designed in the form of a hollow piston. Such a hollow piston can have different outside diameters in axially different regions, which diameters from the different outer effective diameters. Therefore, a hollow piston of this kind as a seal ring carrier can also be referred to as a stepped piston, which, however, is not intended to exclude a soft transition between the two effective diameters.

The “floating” seal ring of the stator is preferably fastened on the rotor-side end face of the hollow piston, which is mounted in the stationary housing part so as to be axially movable, in order to seal in a sliding manner against the rotating rotor seal ring, with a variable contact pressure and variable clearance. The switching from the first to the second balance ratio takes place hydraulically by pressurization on the second outside effective diameter of the hollow piston by opening the balance ratio switching device. This applies correspondingly for a floating rotor seal ring.

In order to act, or not, on the second effective diameter of the seal ring carrier or hollow piston in a pressure-dependent manner, i.e. depending on the medium pressure in the media main channel, with the medium pressure of the media main channel, the balance ratio switching device preferably comprises a balance ratio control valve in the stationary housing part, which control valve actuates the balance ratio control channel in that the balance ratio control valve opens when the medium pressure present from the media main channel in the branch switching channel exceeds the switching threshold value. By opening the balance ratio control valve, the medium currently present in the media main channel is introduced, at the medium pressure from the media main channel, in parallel into the balance ratio control channel, and there pressurizes the second effective diameter. When the medium pressure present at the balance ratio control valve, from the media main channel, via the branch switching channel, falls back below the switch-back threshold value, the balance ratio control valve closes again. Preferably, the residual pressure remaining in the balance ratio control channel is relieved, in order to set the second effective diameter to a state without pressure. In other words, the increase in the medium pressure in the media main channel above the switching threshold value causes the balance ratio control valve to open, and/or the drop in the medium pressure in the media main channel below the switch-back threshold value cause the balance ratio control valve to close. By opening the balance ratio control valve, the balance ratio control channel, and thus the second balance ratio, is activated, and/or by closing the balance ratio control valve, the balance ratio control channel, and thus the second balance ratio, are deactivated. The balance ratio control valve is in particular a spring-loaded valve having a predefined switching pressure. The balance ratio control valve is furthermore in particular arranged in a parallel channel in parallel with the media main channel.

In particular, the balance ratio control valve opens or closes the fluidic connection between the media main channel and the balance ratio control channel, in that the medium pressure from the media main channel acts on the second effective diameter of the seal ring carrier, via the balance ratio control channel, when the balance ratio control valve is opened by the medium pressure in the branch switching channel, and/or the medium pressure from the media main channel does not act on the second effective diameter of the seal ring carrier when the balance ratio control valve is closed.

With respect to the first balance ratio, the medium pressure from the media main channel acts on the first effective diameter of the seal ring carrier, in particular irrespective of whether the balance ratio control valve is open or closed.

According to one embodiment, the branch switching channel opens directly through the balance ratio control valve into the balance ratio control channel, such that the medium from the media main channel acts, with medium pressure, on the balance ratio control channel via the branch switching channel and through the balance ratio control valve, when the balance ratio control valve is open, or the balance ratio control channel branches off from the media main channel, in the stationary housing part, in particularly radially to the axis of rotation of the rotary union, and the balance ratio control valve fluidically connects the balance ratio control channel to the media main channel in the case of exceeding of the switching threshold vale within the stationary housing part, as a result of which the medium from the media main channel is caused to act on the balance ratio control channel with medium pressure in each case.

According to one embodiment, the balance ratio control valve is designed as a spring-loaded check valve which opens from the media main channel side and which opens, when the switching threshold value is exceeded in the branch switching channel, and thereby fluidically connects the branch switching channel to the balance ratio control channel, such that the medium is conducted out of the media main channel, via the branch switching channel, through the check valve and into the balance ratio control channel, in a pressurized manner. When the switching threshold value is not met in the media main channel, the check valve closes again and thereby separates the balance ratio control channel from the branch switching channel again.

According to a further embodiment, the balance ratio control valve comprises a plunger which is spring-loaded counter to the medium pressure in the branch switching channel, which plunger forms a seal in a complementary bore of the stationary housing part below the switching threshold value, and is axially displaced when the switching threshold value is exceeded, and thereby releases a fluidic connection between the branch switching channel and the balance ratio control channel, in the form of a gap between the plunger and the bore.

According to a further embodiment, the balance ratio control valve is designed as a spring-loaded valve which opens when the switching threshold value is exceeded in the branch switching channel, and thereby fluidically connects the media main channel to the balance ratio control channel. When the switching threshold value is not met in the branch switching channel, the balance ratio control valve closes again and thereby separates the media main channel from the balance ratio control channel again.

Preferably, the balance ratio control valve comprises a plunger which is rotatable in particular in parallel with the axis of rotation of the rotary union.

According to one embodiment, the balance ratio control valve has a switching inertia such that, upon depressurization of the media main channel, the balance ratio control valve closes so slowly that the balance ratio control channel still has sufficient time, during the closing of the balance ratio control valve, to relieve pressure in the media main channel via the slowly closing balance ratio control valve and thus to be set to a state without pressure, although the medium pressure at this time has already fallen below the switching threshold value.

According to a further embodiment, a separate pressure relief channel is provided, which leads from the balance ratio control channel, for example via an annular channel around the seal ring carrier to the media main channel and comprises a check valve that blocks from the media main channel side, wherein the balance ratio control channel relieves pressure via the pressure relief channel and is in a state without pressure when the media main channel is set to a state without pressure. For this purpose, the check valve preferably has a very low opening pressure, e.g. less than 1 bar, in particular less than 0.1 bar, e.g. 0.04 bar, or even 0 bar. For this purpose, the check valve can be formed with or without a compression spring.

Preferably at least one of the two seal rings, in particular both seal rings, of the mechanical seal is/are formed as silicon carbide seal rings (SiC).

According to one embodiment, the seal ring carrier is sealed in the stationary housing part by means of a secondary seal, and the secondary seal comprises a first and/or second secondary sealing ring. In the case of two secondary sealing rings, these are preferably arranged on the seal ring carrier on axially opposing sides of the balance ratio control channel, in order to seal said seal ring carrier axially on both sides. The first secondary sealing ring can preferably be designed as what is known as a quad ring, and/or the second secondary sealing ring is designed as an elastomer ring having a U-shaped cross section. Preferably, in the case of pressurized closure of the mechanical seal, the secondary seal is tensioned axially and, upon depressurization, pulls the seal ring carrier, together with the stator seal ring, away from the rotor seal ring, in order to open the mechanical seal sufficiently wide for dry running (known as PopOff® function). Thus, virtually unlimited wear-free dry running at high rotational speeds is possible.

The quad ring is preferably biased or preloaded on the seal ring carrier and is axially movable, relative to the stationary housing part, at its outside diameter.

Further preferably, the stationary housing part comprises a peripheral groove for the quad ring, in which the quad ring is accommodated, wherein the quad ring has axial clearance, for axial mobility, in the groove.

A rotary union of this kind can now be operated as follows: The user connects an external compressed gas source, e.g. comprising compressed air, via an external compressed gas supply line, an external valve, and an external distributor or external manifold, to the connection port of the rotary union. Furthermore, the user connects an external media reservoir comprising oil, e.g. cutting oil or hydraulic oil, via an external oil supply line, a further external valve, and the external distributor, to the same connection port of the rotary union, such that both the compressed gas and the pressurized oil are conducted alternately (not simultaneously) via the same connection port into the same media channel in the stationary housing part. Which of the media is currently introduced is set by the user at the external valves. Optionally, alternatively cooling lubricant can also be conducted via the same connection port into the same media channel, if desired. For this purpose, the user connects another external media reservoir comprising cooling lubricant, via an external cooling lubricant supply line, a further external valve, and the external distributor, to the same connection port of the rotary union.

During operation, the user can now introduce compressed gas, in a first time interval, via the compressed gas supply line and the connection port, at a pressure of for example less than or equal to the allowable maximum pressure for compressed gas or an oil-air mixture (RQL/MQL), e.g. less than or equal to 10 bar, into the media main channel, wherein the first balance ratio is established at the mechanical seal, and the rotary union rotates with the compressed gas and the first balance ratio and controlled air leakage. Subsequently, the user ends the compressed-gas operation again. In a later, second time interval, the user introduces the oil, e.g. cutting oil or hydraulic oil, with a high viscosity, e.g. greater than or equal to 6 mm²/s and a higher pressure, e.g. more than 10 bar, into the media main channel, via the oil supply line and the same connection port. Due to the higher oil pressure of e.g. more than 10 bar, in the media main channel, the balance ratio switching device opens the balance ratio control channel to the second effective diameter of the seal ring carrier, such that the second balance ratio is established at the mechanical seal, and the rotary union rotates with the oil and the second balance ratio in a substantially leak-free manner. Subsequently, the user switches off the oil again.

However, the rotary union is also suitable for CL, such that, alternatively, depending on the application, in a second time interval instead of the oil, cooling lubricant can be introduced int the same media main channel, via the cooling lubricant supply line and the same connection port, at a pressure of e.g. more than 10 bar. Due to the cooling lubricant pressure of e.g. more than 10 bar, in the media main channel, the balance ratio switching device (as also during operation with oil) opens the balance ratio control channel to the second effective diameter of the seal ring carrier, such that the second balance ratio is also established at the mechanical seal, and the rotary union rotates with the cooling lubricant and the second balance ratio in a substantially leak-free manner. Subsequently, the user switches off the cooling lubricant again. In a third time interval, the rotary union can be operated without medium, in dry running operation, wherein the mechanical seal is held open by an axial force brought about by the secondary seal.

Thus, the rotary union can be operated, via the same connection port and the same media main channel, successively with different media, including compressible and incompressible media, of the respectively suitable pressures, and the higher or lower balance ratio, suitable for the respective medium, is established in response to the medium pressure.

The rear end of the seal ring carrier, remote from the mechanical seal, preferably opens into the working space or media main channel, which in particular extends coaxially with the rotor, the mechanical seal and/or the seal ring carrier. The rotor preferably comprises just one single central rotor fluid channel. Further preferably, the rotary union comprises just one single axial mechanical seal.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 is a longitudinal section through a rotary union according to one embodiment of the present disclosure, having an open mechanical seal,

FIG. 2 as FIG. 1, but having a closed mechanical seal,

FIG. 3 is a detailed enlargement from FIG. 1, around the mechanical seal and the seal ring carrier,

FIG. 4 is a detailed enlargement from FIG. 2, around the mechanical seal and the seal ring carrier,

FIG. 5 is a detailed enlargement from FIG. 3, around the rotor-side secondary sealing ring,

FIG. 6 is a detailed enlargement from FIG. 4, around the rotor-side secondary sealing ring,

FIG. 7 is a longitudinal section through a rotary union according to a further embodiment of the present disclosure, having an open mechanical seal,

FIG. 8 as FIG. 7, but having a closed mechanical seal,

FIG. 9 is a detailed enlargement from FIG. 7, around the mechanical seal and the seal ring carrier,

FIG. 10 is a detailed enlargement from FIG. 8, around the mechanical seal and the seal ring carrier,

FIG. 11 is a detailed enlargement of the balance ratio switching device from FIG. 7 in the unloaded state,

FIG. 12 as FIG. 11, but having the balance ratio switching device in the actuated state,

FIG. 13 is a longitudinal section through an embodiment modified compared with FIG. 7, having an open mechanical seal,

FIG. 14 as FIG. 13, but having a closed mechanical seal,

FIG. 15 is a longitudinal section through a rotary union according to a further embodiment of the present disclosure, having an open mechanical seal and a balance ratio switching device in the non-actuated state,

FIG. 16 is a cross-section through the rotary union along the line A-A in FIG. 15,

FIG. 17 is a cross-section through the rotary union along the line D-D in FIG. 15,

FIG. 18 is a cross-section through the rotary union along the line E-E in FIG. 15,

FIG. 19 is a rear view of the rotary union from FIG. 15,

FIG. 20 is a longitudinal section through the rotary union along the line B-B in FIG. 19,

FIG. 21 is a detailed enlargement of the balance ratio switching device from FIG. 20,

FIG. 22 as FIG. 15, but having a closed mechanical seal and the balance ratio switching device in the actuated state,

FIG. 23 is a cross-section through the rotary union along the line A-A in FIG. 22,

FIG. 24 is a cross-section through the rotary union along the line D-D in FIG. 22,

FIG. 25 is a cross-section through the rotary union along the line E-E in FIG. 22,

FIG. 26 is a rear view of the rotary union from FIG. 22,

FIG. 27 is a longitudinal section through the rotary union along the line B-B in FIG. 26,

FIG. 28 is a detailed enlargement of the balance ratio switching device from FIG. 27,

FIG. 29 is a schematic view of the diameter ratios of a seal ring assembly comprising a floating seal ring, for calculating the balance ratio,

FIG. 30 is a schematic view of the external media distribution network.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

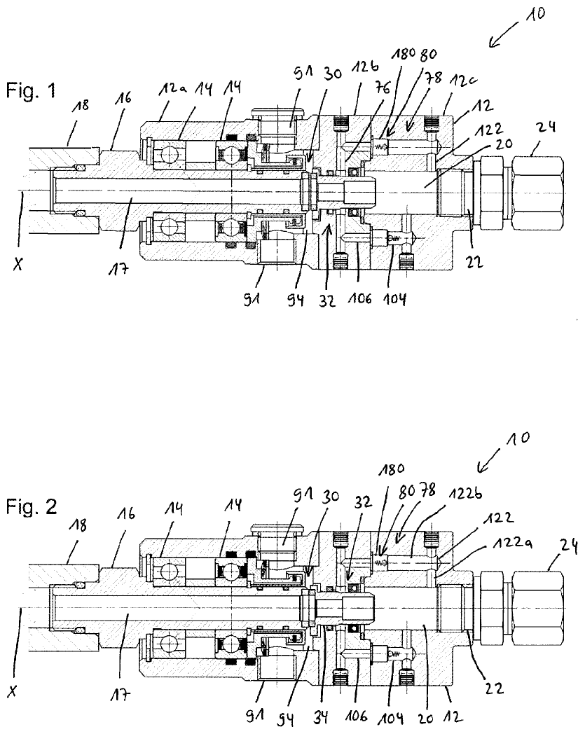

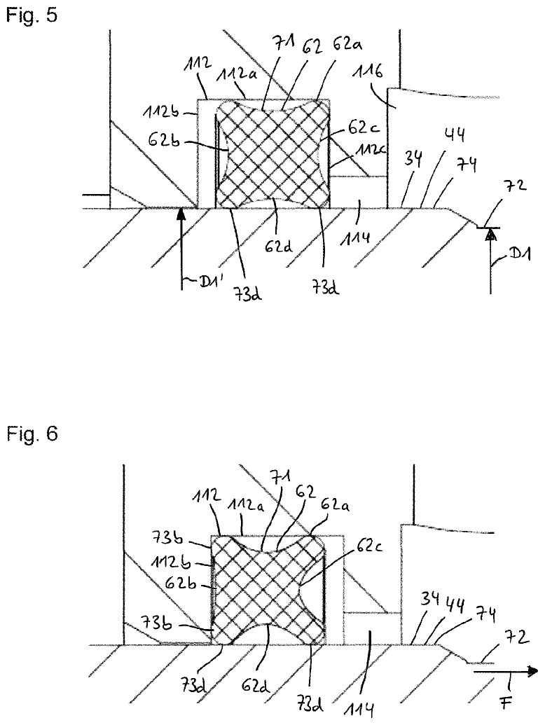

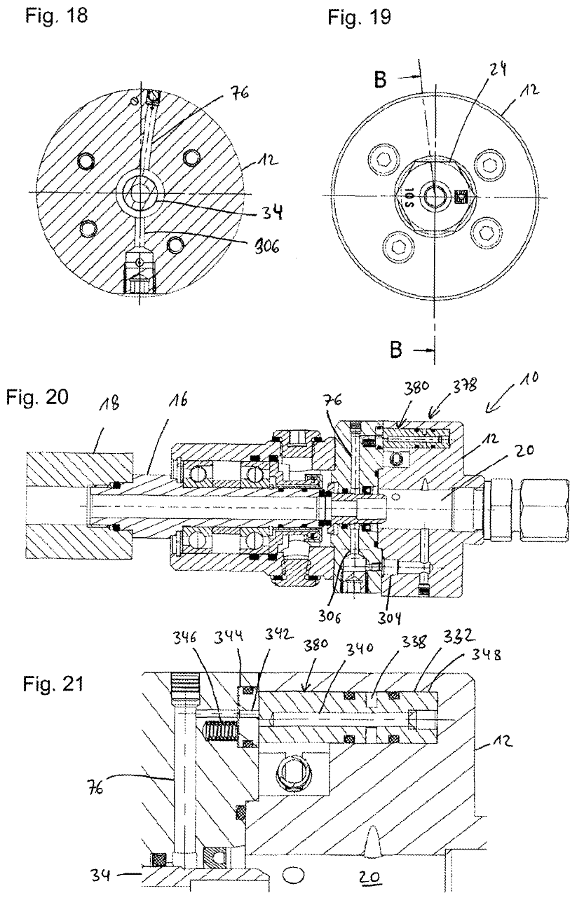

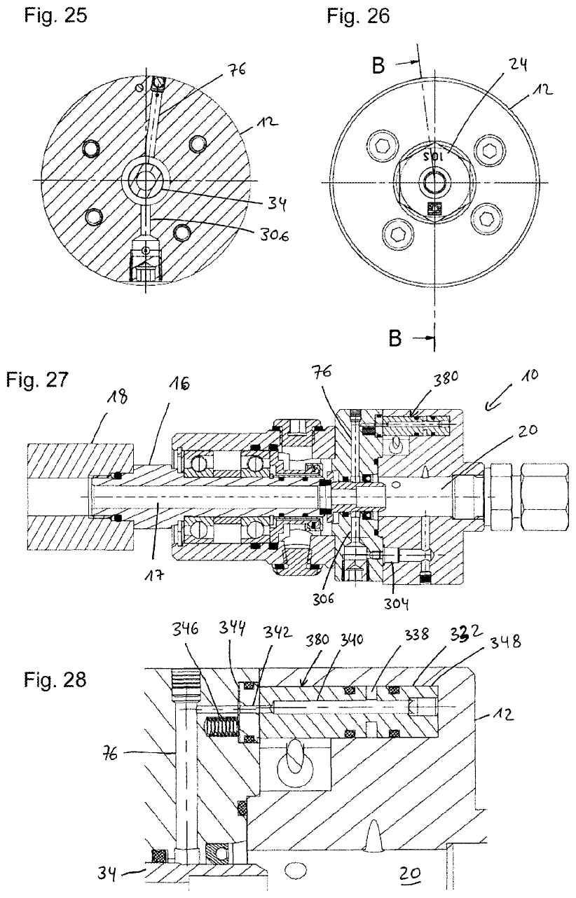

With reference to FIGS. 1 to 28, the rotary union 10 comprises a stationary housing part 12 at the rear, which is formed in multiple parts in the present example. A rotor 16, in these examples in the form of a hollow shaft, for connection to a machine spindle 18 is mounted in the stationary housing part 12 in a rotating manner by means of primary rolling bearings, e.g. ball bearings 14. The rotary union 10 in particular comprises one single media main channel 20 in the stationary housing part 12, and one single connection port 22, e.g. having one single screw-in fitting 24 for connection to suitable tube or pipe systems, in order to introduce the desired fluid media into the stationary housing part 12 of the rotary union 10, under pressurization, via the same connection port 22, into the same media main channel 20 extending coaxially with the axis of rotation X of the rotary union 10. In this case, the media main channel 20 is pressurized alternately and not simultaneously with the currently desired medium, in each case, from a group of the suitable media. In this case, the group of suitable media comprises both compressible and incompressible media. The group of suitable media can in particular comprise on the one hand compressed air, reduced quantity lubrication or minimum quantity lubrication (RQL/MQL) as compressible media, and, on the other hand, cooling lubricant (CL), cutting oil and/or hydraulic oil as incompressible media. In this case, the rotary union is in particular operable at least by means of compressed air on the one hand and by means of an oil, e.g. cutting oil or hydraulic oil, on the other hand.

The stationary housing part 12 and the rotor 16 are sealed by means of an axial mechanical seal 30. The mechanical seal 30 comprises a seal ring assembly 32 comprising an axially displaceable seal ring carrier 34 and a seal ring 36 fastened to the seal ring carrier 34. The seal ring 36 of the stator, or stator seal ring 36 for short, seals, with its rotor-side axial annular sealing surface 36a, against a rear axial annular sealing surface 38a of the complementary seal ring 38 of the rotor 16. The seal ring 38 of the rotor 16, or rotor seal ring 38 for short, is fastened on the stator-side end face 16a of the rotor 16, in these examples pressed and/or adhesively bonded into an annular groove 42, wherein other fastening techniques are also possible, however.

The seal ring carrier 34 of the stator seal ring 36 is designed for example as a hollow piston 44 and mounted in the stationary housing part 12 in particular in a torsion-proof, but axially movable, manner. The seal ring carrier comprises a rotor-side flange 46 which is accommodated in a torsion-proof manner in a corresponding rotor-side recess 48 in the stationary housing part 12. The torsion prevention can be implemented for example by two axial pins in the stationary housing part 12, which pins establish a form-fitting connection in opposing grooves on the seal ring carrier flange 46 (pins not shown in the drawings, for reasons of clarity). The stator seal ring 36 is fastened, e.g. pressed in or adhesively bonded, at the end face on the rotor-side end 34a of the seal ring carrier 34 or hollow piston 44, wherein other fastening techniques are also possible, however. In the present examples, the stator seal ring 36 is, by way of example, permanently fastened in a recess 52 of the seal ring carrier 34, more precisely of the flange 46.

The seal rings 36, 38 preferably both consist of silicon carbide (SiC), such that reference is often made to a SiC—SiC mechanical seal 30. A SiC—SiC mechanical seal 30 is durable and has excellent sealing properties during operation with liquid, highly lubricating media. However, some conventional rotary unions have stability problems in the case of operation with compressed air or in dry running with silicon carbide seals. SiC seal rings can for example overheat, if they run without lubricant and are not sufficiently separated from one another, which can lead even to complete failure of the rotary union. This can be prevented by means of the present disclosure. However, other materials can also be considered for the seal rings 36, 38, such as carbon graphite (CG), i.e. for example a CG-SiC mechanical seal, or tungsten carbide (TC).

The seal ring assembly 32 of the stator, or stator seal ring assembly 32 for short, or the hollow piston 44, is mounted in the stationary housing part 12 so as to be axially displaceable, by means of a secondary seal 60. In these examples, the secondary seal 60 comprises first and second secondary sealing rings 62, 64 in the form of two elastomer annular seals. In the present examples, the rotor-side first elastomer annular seal 62 is formed as an elastomer quad ring 62, for example from a fluorelastomer, such as Viton®. In the present examples, the stator-side or rear elastomer second annular seal 64 has a U-shaped cross section having a groove 66 which is open at the high-pressure side, and which is fluidically connected to the media main channel 20. Said second annular seal 64 is therefore sometimes also referred to as a U-cup ring.

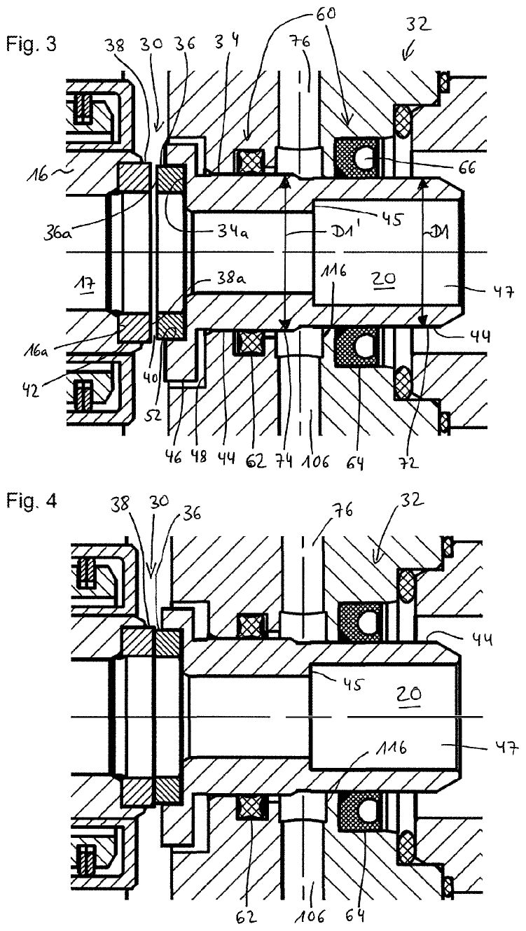

The mounting of the seal ring carrier 34 or the hollow piston 44 by means of the two elastomer annular seals 62, 64 allows the stator seal ring assembly 32 or the stator seal ring 36 a limited axial mobility, in order to be able to close the mechanical seal 30 and open it again. Typically, during operation with pressurized fluid media having liquid lubricant fractions, such as CL, cutting oil or hydraulic oil, the mechanical seal 30 is closed, such that at most a minimal optionally dropwise, leakage (known as bleeding) occurs. When the mechanical seal 30 is closed, such media ensure sufficient lubrication between the two silicon carbide sliding surfaces 36a, 38a. However, in dry running or in compressed-air operation, in the closed state, the two silicon carbide seal rings 36, 38 could rub against one another and heat up excessively. In order to prevent this, the mechanical seal 30 opens upon depressurization or in compressed-air operation, in that the seal ring carrier 34 or the hollow piston 44 together with the stator seal ring 36, i.e. the stator seal ring assembly 32, detaches from the rotor seal ring 38 and moves slightly axially away from this in the axial direction, i.e. to the right in the present figures, such that a sealing gap 40 results between the seal rings 36, 38 (most clearly visible in FIGS. 3 and 9). In the present example, the closing process in the case of pressurization can be improved by an inner diaphragm 45 in the axial bore 47 of the hollow piston 44.

In the present embodiments, the two elastomer annular seals 62, 64 together form the secondary seal 60 of the stationary part of the rotary union 10. The elastomer secondary seal 60 thus fulfils a dual function for the stator seal ring assembly 32, specifically as an axially displaceable mounting on the one hand, and as a seal against the pressurization with fluid medium from the stationary side, in the stationary housing part 12, on the other hand.

On account of the mounting by means of the elastomer sealing rings 62, 64, the stator seal ring assembly 32 may also have a slight tilting capacity, such that the sealing surfaces 36a, 38a of the two seal rings 36, 38 of the primary seal 30 rest completely flat against one another in the pressurized state, and can achieve a correspondingly good sealing effect. A stator seal ring 36 of this kind, which is axially displaceable in this way and is optionally slightly tiltable, is also referred to by experts as a floating seal ring.

In the open state of the mechanical seal 30 the sealing gap 40 between the seal rings 36, 38 is present, wherein the sealing gap 40 may be shown exaggerated in the figures for better illustration. This applies in particular in compressed-air operation, since in this case only a controlled, not excessively great air leakage is desirable. Thus, in the open state of the mechanical seal 30, e.g. in compressed-air operation, a certain air leakage rate results, which, in the present embodiments, can be approximately 15-20 standard liters per minute, i.e. is significantly lower than in the case of some conventional rotary unions. Furthermore, the present rotary union 10 has excellent dry running properties, since in dry running excessive heating of the seal rings 36, 38 can be prevented. The rotary union can therefore be operated in a largely unlimited manner with high rotational speeds, both without pressure during dry running, and in particular with compressed air in an allowable pressure interval of e.g. up to 10 bar.

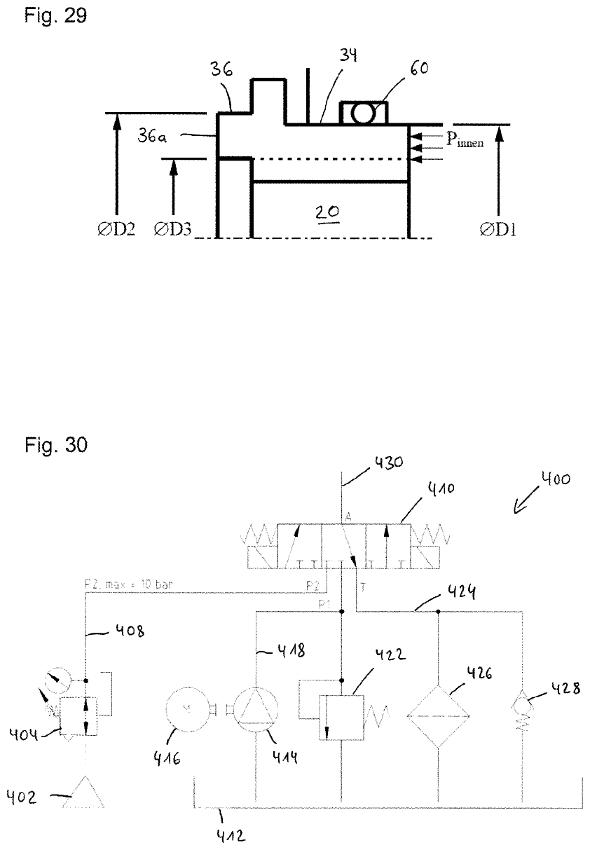

With reference to FIG. 29, the balance ratio B of a floating seal ring is defined by the area ratio FH/F of the hydraulically or pneumatically loaded surface FH to the contact surface F between the two seal rings 36, 38. Thus, the balance ratio B can be calculated geometrically, on the basis of the diameters D1, D2 and D3, as follows:

$$B = \frac{{F}_{H}}{F} = \frac{D {1}^{2} - D {3}^{2}}{D {2}^{2} - D {3}^{2}}$$

wherein D1 is the outside diameter or effective diameter of the pressurized seal ring carrier, D2 is the outside diameter of the contact surface of the mechanical seal, and D3 is the inside diameter of the contact surface of the mechanical seal.

In the present embodiments, the hollow piston 44 is designed as a stepped piston, and thus comprises a stator-side first axial region 72 having a first outside diameter D1, and a rotor-side second axial region 74 having a larger second outside diameter D1′ (D1′>D1).

A balance ratio control channel 76 is interconnected internally, and extends inside the stationary housing part 12. The balance ratio control channel 76 opens on the peripheral outer side of the seal ring carrier 34 or hollow piston 44 and is arranged such that the larger second outside diameter D1′ of the hollow piston 44 is pressurized, via the balance ratio control channel 76, with the medium introduced into the media main channel 20, when the balance ratio control channel 76 is activated, i.e. is pressurized with medium from the media main channel 20. Accordingly, there is a fluidic connection between the balance ratio control channel 76 and the second axial region 74 with the larger second outside diameter D1′ of the seal ring carrier 34 or hollow piston 44. A pressurized introduction of fluid medium, via the connection port 22, into the media main channel 20 therefore leads not only to pressurized introduction of the fluid medium into the media main channel 20, and from there into the rotor fluid channel 17, but rather also pressurizes the second axial region 74 with the outside diameter D1′ of the seal ring carrier 34 or hollow piston 44 with the medium, when and only when the balance ratio control channel 76 is activated, i.e. is acted on with the medium pressure.

In the present case, the activation of the balance ratio control channel 76 is controlled, i.e. activated and deactivated, by means of a new balance ratio switching device 78, via the medium pressure in the media main channel 20, which will be explained in more detail in the following, with reference to the embodiments. As a result, all common media, including compressed air, reduced quantity lubrication (RQL/MQL), cutting oil, hydraulic oil and cooling lubricant (CL) can be transferred into the machine tool spindle 18, under pressure and rotation, via the same media main channel 20. In addition, temporally unlimited dry running, i.e. rotation without medium present, is possible.

Some functions of the present embodiments are based on the rotary union disclosed in the patent applications DE 10 2021 111 688 and DE 10 2021 111 690, which are hereby incorporated by reference. In contrast to the rotary union described in DE 10 2021 111 688 and DE 10 2021 111 690, the rotary unions 10 disclosed in the present case and shown in FIGS. 1 to 28 contain, however, just one single media main channel 20 and just one single connection port 22, instead of a plurality thereof.

In the present disclosure, the actuation of the balance ratio control channel 76 is brought about in particular by the balance ratio switching device 78 in the form of a valve controller integrated in the stationary housing part 12.

The balance ratio switching device 78 in particular comprises a balance ratio control valve 80 which switches the mechanical seal 30 back and forth between the smaller first and the greater second balance ratio B and B′, respectively, in that on the one hand, in the case of non-actuation of the balance ratio control device 78, the balance ratio control valve 80 is closed, and as a result the balance ratio control channel 76, and thus the larger second effective diameter D1′, is not pressurize with the medium pressure from the media main channel 20, such that the smaller first balance ratio B is established, and in that, on the other hand, the balance ratio control valve 80 is opened by actuation of the balance ratio switching device 78 and as a result the balance ratio control channel 76 and thus the larger second effective diameter D1′ is pressurized with medium pressure from the same media main channel 20, such that the larger second balance ratio B′ is established.

When the balance ratio switching device 78 is actuated, i.e. the balance ratio control valve 80 opens, as a result the larger second effective diameter D1′ is acted on by the medium pressure from the media main channel 20, as a result of which the closing forces of the mechanical seal 30 can be increased compared with in the smaller first effective diameter D1.

With reference to the first embodiment according to FIGS. 1 to 6, the actuation of the balance ratio control channel 76 takes place via an overpressure valve 180, opening from the media main channel side, as the balance ratio control valve 80, and a release valve 104. The through-flow direction of the overpressure valve 180 is from the media main channel 20 into the balance ratio control channel 76. The opening pressure or switching point of the spring-loaded overpressure valve 180 is selected such that said valve is actuated, i.e. opens, only in CL or cutting oil or hydraulic oil applications having typical pressures of >10 bar, and, in the closed state, sets the balance ratio control channel 76 under the medium pressure. The use of compressed air is limited, in the case of this rotary union, to a maximum of 10 bar, such that the overpressure valve 180 remains unactuated, i.e. closed, upon application of compressed air of less than or equal to 10 bar.

When the medium pressure, in particular in the case of CL or cutting oil/hydraulic oil application, thus exceeds a predefined switching threshold value p_{U}, the overpressure valve 180 opens, and then the same pressure prevails in the balance ratio control channel 76 as in the media main channel 20. In the present examples, the switching threshold value p_{U} is selected so as to be slightly greater than the maximum allowable pressure for compressed air, i.e. p_{U}>10 bar, e.g. p_{U}=20 bar.

When the overpressure valve 180 is actuated or open, said medium pressure now acts, via the balance ratio control channel 76, on the larger hydraulic effective area, which is defined by the larger second outside diameter D1′ of the hollow piston 44, and thereby increases the closing force of the mechanical seal 30. In this embodiment, the first balance ratio B, brought about by the smaller first outside diameter D1, i.e. when the overpressure valve 180 is closed, is nominally 0.50, and the larger second balance ratio B′, brought about by the larger second outside diameter D1′, i.e. when the overpressure valve 180 is open, is nominally 0.64. As a result, in the case of CL or cutting oil/hydraulic oil application, the mechanical seal 30 remains virtually leak-free, and the lubrication film between the sealing surfaces 36a, 38a prevents wear of the mechanical seal 30.

In other words, the balance ratio control valve 80, in this embodiment in the form of a spring-loaded overpressure valve 180, is actuated, i.e. opened, in that the medium pressure in the media main channel 20 exceeds the switching threshold value p_{U}, as a result of which the balance ratio control channel 76 is connected, in terms of pressure technology, to the media main channel 20, in the flow direction from the media main channel side, such that the medium pressure from the media main channel 20 also prevails in the balance ratio control channel 76.

In this embodiment, the pressure relief in the control channel 76, once the CL or cutting oil or hydraulic oil application has ended, takes place via a check valve as a release valve 104 in the pressure relief channel 106. When the media main channel 20 is set to the state without pressure, and thereby falls below a switch-back threshold value p_{R} (in this example p_{U}=p_{R}), the overpressure valve 180 closes, but a flow can pass through the check valve 104, from the side of the balance ratio control channel 76 in the direction of the media main channel 20, in order to set the larger second effective diameter D1′ to the state without pressure again. The opening pressure of the check valve 104 can be selected so as to be very low, for example 0 bar or 0.04 bar.

During operation with CL or cutting oil or hydraulic oil, a pressure equilibrium prevails, via the open overpressure valve 180, between the media main channel 20 and the balance ratio control channel 76, as a result of which, in this state, the setting of the check valve 104 is irrelevant for the function of the rotary union 10. If, in the case of use of CL or cutting oil or hydraulic oil, a switch is made to compressed air, the media main channel 20 is in a state without pressure for a short intermediate time period. During this state without pressure, the overpressure valve 180 is closed, and the check valve 104 opens due to the overpressure, possibly still present in the balance ratio control channel 76, relative to the media main channel, in order to thereby relieve the pressure in the balance ratio control channel 76, depending on the selection of the check valve 104, e.g. to 0 bar or 0.04 bar, such that again the smaller first balance ratio B is effective, which is defined by the smaller first effective diameter D1.

In the present embodiments, the maximum allowable pressure in compressed-air application is 10 bar, such that the overpressure valve 180, on account of the switching threshold value p_{U} which is greater than the maximum allowable pressure in compressed-air operation, remains closed in the case of compressed-air application. The balance ratio control channel 76 thus remains in the state without pressure, as long as the pressure in the media main channel 20 does not exceed the switching threshold value, such that only the smaller hydraulic area, defined by the smaller first effective diameter D1, is acted on by the medium pressure of the media main channel 20. As a result, the smaller first balance ratio B of the mechanical seal 30 is established, in this example nominally B=0.5. Owing to the smaller first balance ratio B, in compressed-air operation a smaller sealing gap 40 results between the two seal rings 36, 38, such that no wear occurs on the seal rings and a small, controlled air leakage can escape. However, in the case of liquid media of high viscosity, such as cutting oil or hydraulic oil, when the smaller first balance ratio B is present said sealing gap 40 would increase in size excessively, and an undesired high liquid leakage would occur, which, however is prevented by the present switching to the larger second balance ratio B′.

If no pressure at all is present in the media main channel 20, the balance ratio control channel 76 also remains without pressure, and the secondary seal 60 can pull back the floating seal ring 36 by means of what is known as the Pop-Off® effect, such that there is no contact of the seal ring surfaces 36a, 38a, and also an unlimited dry running can take place.

Due to the mode of operation of the balance ratio switching device 80, e.g. in the form of the described valve assembly, the mechanical seal 30 accordingly has the following states:

| | Pressure, | Pressure, | State, | State, | |
|---|---|---|---|---|---|
| | main | control | Valve | Valve | Nominal |
| Medium | channel | channel | A | B | balance |
| Compressed | <10 bar | approx. 0 bar | closed | closed | 50% |
| air | | | | | |
| Cutting oil | >10 bar | =pressure, | open | undefined | 64% |
| | | main channel | | | |
| CL | >10 bar | =pressure, | open | undefined | 64% |
| | | main channel | | | |
| Without | 0 bar | approx. 0 bar | closed | closed | — |
| pressure/ | | | | | |
| dry running | | | | | |

wherein valve A is the overpressure valve 180 and valve B is the release valve 104.

Accordingly, the rotary union has the smaller first balance ratio B, as long as the pressure in the media main channel 20 remains below the balance ratio switching threshold value p_{U}. In the present example, the balance ratio switching threshold value p_{U} is defined as the switching point by the overpressure valve 180, and can for example be 20 bar.

The media main channel 20 is connected, via a branch switching channel 122 in which the balance ratio control valve 80 is located, to the balance ratio control channel 76 in the interior of the stationary housing part 12, when the balance ratio control valve 80 is opened. In this embodiment, the branch switching channel 122 initially branches radially 122a from the media main channel 20 and extends, with an axial portion 122b, slightly further, in parallel with the media main channel 20. The overpressure valve 180 is located in the branch switching channel 122 or, in the present example, in the axial portion 122b, such that the pressure of the media main channel 20 is applied at the overpressure valve 180, via the branch switching channel 122. Thus, the branch switching channel 122 together with the balance ratio control valve 80 forms a medium path in parallel with the media main channel 20. When the medium pressure in the media main channel 20, and thus in the branch switching channel 122, exceeds the switching threshold value, the overpressure valve 180 opens and conveys the medium out of the media main channel 20, with the corresponding medium pressure, through the overpressure valve 180 and into the balance ratio control channel 76, such that the medium pressure from the media main channel 20 prevails not only at the smaller first effective diameter D1, but rather simultaneously also at the larger second effective diameter D1′, and thus the greater second balance ratio B′ is effective, which is calculated as follows:

$${B}^{′} = \frac{{F}_{H}^{′}}{F} = \frac{D {1}^{′2} - D {3}^{2}}{D {2}^{2} - D {3}^{2}} > B$$

Depending on whether the balance ratio control channel 76 is acted on or not by the fluid medium from the media main channel 20, depending on whether the switching threshold value p_{U} is exceeded or not exceeded, the mechanical seal 30 accordingly has a different balance ratio, specifically B when said switching threshold value is not exceeded, and B′ when it is exceeded.

Thus, in the embodiment shown in FIGS. 1 to 6, the overpressure valve 180 forms a balance ratio switching device 78 for the mechanical seal 30, which switches the mechanical seal 30 automatically from B to B′ when the medium pressure in the media main channel 20 exceeds the switching threshold value p_{U}, and thereby actuates the overpressure valve 180 for opening.

Thus, in the present disclosure, the switching between the balance ratios B and B′ is controlled or triggered in response to the magnitude of the prevailing medium pressure in the media main channel 20. At low pressure, the smaller first balance ratio B is established, and at higher pressure the rotary union switches automatically, in a hydraulically controlled manner, to the larger second balance ratio B′. As a result, one single media main channel is sufficient, into which channel all desired media can be introduced alternately in succession.

Due to the different balance ratios B, B′, adjusted to the respective medium, in the case of a circuit with cooling lubricant or cutting oil or hydraulic oil, a high degree of tightness of the mechanical seal 30, and in the case of compressed-air operation a relatively low air leakage rate in the range of 15-20 standard liters per minute, as well as good dry running properties and high stability can be brought into line with one another. Furthermore, in the case of operation with cooling lubricant, a high pressure, e.g. in particular greater than 90 bar, can be used, and the leakage rate nonetheless remains in an acceptable range, or the mechanical seal 30 is substantially leak-free. The embodiment can be operated with liquid media, CL or cutting oil optionally at e.g. up to 140 bar or even up to 210 bar, and with compressed air up to 10 bar, and with MQL up to 10 bar.

Leakage ports 91 for discharging a slight remaining leakage of cooling lubricant or cutting oil or hydraulic oil are provided at various angles, and can be used depending on the installation position of the rotary union 10. A leakage connection coupling can be connected at the desired leakage port 91, in order to discharge leakage fluid or the controlled air leakage from a leakage chamber 94 outside the mechanical seal 30.

The stationary housing part 12 is preferably formed as a multipart feedthrough housing or multipart rotary union housing, such that, on account of the modular design, simple adaptability to existing housing shapes is possible. In the present examples, the stationary housing part 12 is formed in three parts and comprises a rotor housing 12a, in which the rotor 16 is mounted by means of the ball bearings 14, an intermediate housing part 12b, in which the stator seal ring assembly 32 is mounted in an axially displaceable manner and in which a part of the balance ratio control channel 76 extends, and a rear housing part 12c in which the media main channel 20 extends axially and into which the connection port 22 leads axially. Other housing designs are also possible, however.

With reference to FIGS. 3 to 6, in this example the quad ring 62 is preloaded on the rotor-side axial region 74 of the hollow piston 44 having the larger second outside diameter D1′, and is accommodated in the stationary housing part 12, in particular in the intermediate housing part 12b, in a groove 112 extending around the hollow piston 44. In this example, the quad ring 62 has sufficient clearance, relative to the groove base 112a, in order to be able to move relative to the stationary housing part 12 in the case of an axial displacement of the hollow piston 44 within the groove 112 that is produced having an axial oversize. The quad ring or X-ring 62 forms a lip seal, in particular a multi lip seal.

In the pressurized state shown in FIG. 6, the quad ring 62 is pressed, by the hydraulic pressure, against the rotor-side annular wall 112b of the groove 112, and deforms elastically in the process, with its shaping that is concave on four sides, in cross section. In particular, the rotor-side concave end face 62b deforms at the wall 112b. In this case, the hydraulic pressure can act successfully on the concave end face 62c of the quad ring 62 facing away from the rotor, and can move this, together with the hollow piston 44, in the direction of the rotor 16, and press the quad ring 62 against the annular wall 112b in an elastically deforming manner. Thus, in the case of pressurization of the balance ratio control channel 76, not only is the higher balance ratio B′ established at the two seal rings 36, 38, in order to achieve an adequate sealing effect at the primary seal 30, for example during operation using cutting oil or hydraulic oil, but rather the quad ring 62 is also elastically deformed, in cross-section, by pressing by the medium pressure against the side wall 112b. For this purpose, the balance ratio control channel 76 is fluidically connected to the quad ring groove 112 via a connecting channel 114, such that the hydraulic pressure existing in the balance ratio control channel 76 can exert an axial force, on the quad ring 62, acting in the direction of the rotor 16. In the present example, the connecting channel 114 is formed as a peripheral annular groove around the hollow piston 44, in order to uniformly apply hydraulic pressure to the quad ring 62 all around. Furthermore, in the present example, the balance ratio control channel 76 opens into a control channel groove 116 surrounding the hollow piston 44, in the form of an annular groove, which is in fluidic communication, axially, with the connecting channel 114.

In the case of depressurization of the balance ratio control channel 76, the deformation by resilient relaxation of the quad ring 62, in particular of the rotor-side quad ring end face 62b which is concave in the unloaded state, generates an axial force component F facing away from the rotor 16, in that the quad ring 62 presses away from the annular wall 112b by resilient shape recovery. Due to the radial preload of the quad ring 62 on the hollow piston 44, the quad ring 62 transmits, by its resilient shape recovery, the axial force component F to the seal ring carrier 34 or hollow piston 44 away from the rotor 16. In this case, the quad ring 62 sits with its concave inside 62d, with two sealing lips 73d on the outside diameter D1′ of the hollow piston in a preloaded manner, as a result of which a good entrainment is ensured. The quad ring 62 thus carries the hollow piston 44 along axially, in that the force component F, exerted by the resilient shape recovery, from the quad ring 62, acts on the hollow piston 44, and thus at least contributes to opening the mechanical seal 30 upon depressurization of the media main channel and of the balance ratio control channel 76. At the same time, the outer periphery 62a of the quad ring 62 provides sufficient sealing against the groove base 112a such that, in the case of pressurization with liquid medium via the balance ratio control channel 76, the quad ring 62 is pressed, by the medium pressure, against the rotor-side annular wall 112b, and is elastically deformed in the process. In said pressurized elastically deformed state of the quad ring 62, then in particular the rotor-side end face 62b and/or the radial inner side 62d of the quad ring 62 provide sufficient sealing against the rotor-side annular wall 112b or the outside diameter D1′, in order to prevent undesired leakage at the secondary seal 60. Upon pressurization, the quad ring 62 seals, by two sealing lips 73b, against the rotor-side annular wall 112b of the stationary housing part 12, and pushes away from the annular wall 112b again, by the two sealing lips 73b, upon pressure relief. An elastomer ring of this kind advantageously has defined deformation properties.

The open state of the mechanical seal is shown in FIGS. 1, 3 and 5, wherein the air gap 40 may be shown exaggerated for illustration. In the open state, the quad ring 62 can, by contact on the peripheral annular wall 112c of the groove 112 facing away from the rotor, also find a stop for the axial movement of the hollow piston 44 or the stator seal ring assembly 32.

Thus, the quad ring 62 preloaded on the hollow piston 44 moves together with the hollow piston 44 between the closed and open state of the mechanical seal 30, wherein the quad ring 62 moves axially within the annular groove 112 produced having an axial oversize, in particular between the two annular walls 112b and 112c.

Thus, the first secondary sealing ring, formed in this example as a quad ring 62, forms an elastomer shape-recovery element 71, which contributes to a reliable Pop-Off® upon depressurization of the liquid medium. However, embodiments of the present disclosure can also be equipped with other secondary sealing rings 62, 64.

In the present case, the switching between the different balance ratios B and B′ takes place purely mechanically/physically by the magnitude of the medium pressure of the medium introduced in each case, i.e. by increasing the pressure above the pressure threshold value ps or lowering the pressure below the pressure threshold value ps, in particular by depressurization.

In summary, a reliable, all media-compatible rotary union 10 can be provided, in which both compressible media, e.g. compressed air or RQL/MQL and also incompressible media, such as cooling lubricant (CL), cutting oil or hydraulic oil, can be introduced in succession into the same media main channel 20, in a pressurized manner. In this case, a high degree of reliability and variability for operation with all the different media is ensured.

Adding the second effective diameter D1′ on the hollow piston 44 increases the balance ratio relative to the first effective diameter D1 from B to B′, such that the sealing surfaces 36a, 38a remain closed or have a sufficiently low leakage rate or operate in a substantially leak-free manner (switching leakage or bleeding), even upon application of higher-viscosity liquid media, such as cutting oil or hydraulic oil, when the balance ratio control channel 76 is activated.

With reference to FIG. 30, the rotary union 10 is supplied with the desired fluid media from an external media distribution network 400. For compressed-air operation, a compressed-air source 402 is connected, via a control valve 404 and a compressed-air supply line 408, to an external distributor 410. For operation using cutting oil, hydraulic oil or CL, a tank 412, as a media reservoir for cutting oil, hydraulic oil or CL as the liquid medium, is connected via a pump 414 to a motor 416 and an external liquid medium pressure supply line 418 (depending on what medium is desired, as an oil supply line or cooling lubricant supply line) is connected to the external distributor 410. The pump 414 generates the desired media pressure P1 for the cutting oil, hydraulic oil or CL, which can be e.g. up to 210 bar. In order to prevent excess pressure, the liquid pressure is limited by a pressure limiting valve 422 which leads back into the tank 412. Upon switching off of the liquid medium, the residual pressure of the liquid medium can be relieved back into the tank 412 again, via a return line 424 and a filter 426 having a parallel check valve 428, in order to set the media main channel 20 into a state without pressure.

In the present example, the external distributor 410 is designed as a three-way valve (compressed air, liquid, return), and forms a media selection distributor for selecting the medium desired in each case. From the distributor 410, a pressure line leads, as a common connection line 430 for all media, to the common connection port 22, in order to introduce all the media, via the same connection port 22, into the same media main channel 20, alternately and in succession, in a pressurized manner.

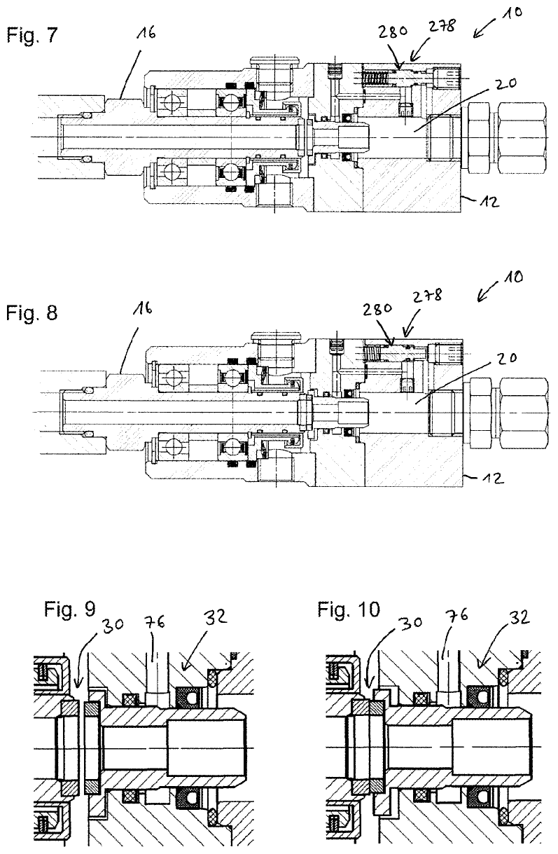

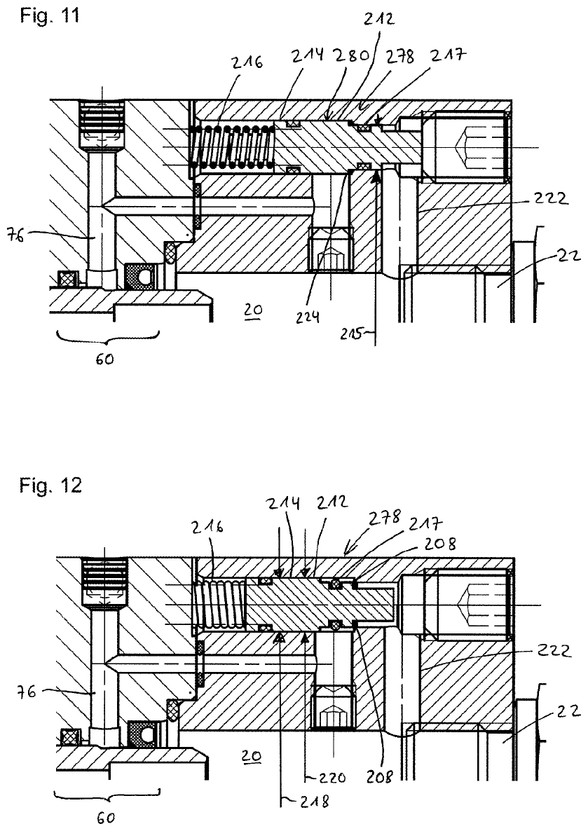

With reference to FIGS. 7 to 12, a further embodiment of the rotary union 10 comprises a balance ratio switching device 278 having a balance ratio control valve 280, which comprises a plunger 212 that is arranged in an axially displaceable manner in a bore 214. A spring 216 holds the plunger 212 in the closed position, in the state without pressure (cf. FIG. 11). The spring force of the spring 216 defines the switching threshold value p_{U} for the medium pressure. If the medium pressure in the media main channel 20 and the branch switching channel 222 branching off from this is greater than the spring force of the valve spring 216, the plunger 212 is displaced axially, such that a gap 208 opens between the plunger 212 and the bore 214, which opens the fluid path for the medium from the branch switching channel 222 into the balance ratio control channel 76, such that the second effective diameter D1′ is acted on with the medium pressure from the media main channel 20. Accordingly, if the medium pressure exceeds the switching threshold value p_{U}, which is defined by the spring-loaded plunger 212, in the present example p_{U}>10 bar, the plunger 212 is initially actuated via a first effective diameter 215, specifically when the force brought about by the medium pressure is greater than the spring force of the spring 216, which results in the plunger 212 moving to the left in the drawing. If the sealing element 217, e.g. an O-ring, has entered the larger diameter 218 of the bore 214, then this has a dual effect. Firstly, the larger effective diameter 220 of the plunger 212 is activated, which brings about an acceleration of the movement of the plunger 212 counter to the spring force 216, until the plunger 212 strikes against a stop. Secondly, the medium pressure can now also enter the balance ratio control channel 76, via the gap 208, and activate the larger second effective diameter D1′ of the mechanical seal at the floating seal ring 36, which brings about an increased closing force of the mechanical seal. For cooling lubricant, this additional force component would typically not be essential, but for media of higher viscosity, such as cutting oil or hydraulic oil, the higher closing force, brought about by the greater second balance ratio B′, extremely advantageous, since the mechanical seal thus remains closed even in the case of higher medium pressures, and excessive leakage can be prevented.

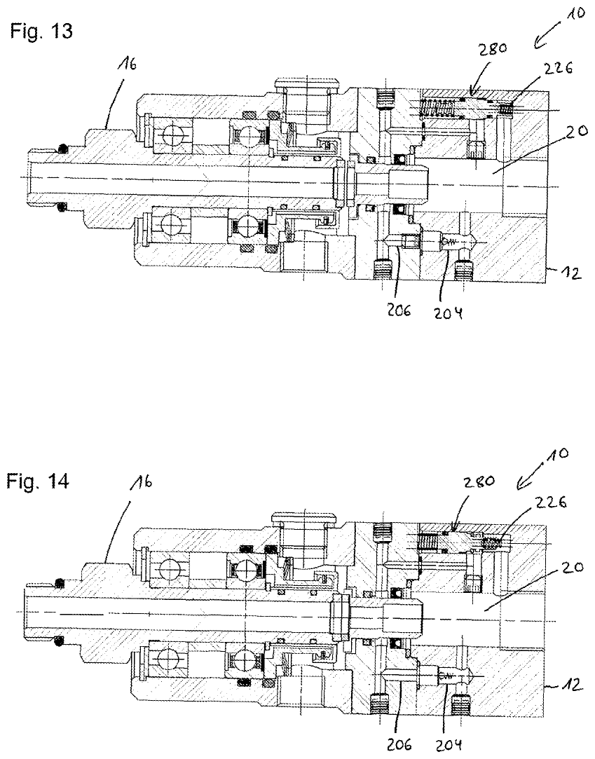

Upon switching off of the medium pressure, or falling below the switch-back threshold value p_{R}, the plunger 212 is pushed back onto a closure stop 224, by means of the compression spring 216, and thus the balance ratio control valve 280 is closed again. In this embodiment, the balance ratio control valve 280 comprising the plunger 212 has a certain switching inertia, in that the movement of the plunger 212 in the closing direction, i.e. to the right in the drawing, takes a relatively long time. As a result, the relatively small volume of the balance ratio control channel 76 between the hollow piston 44 and the plunger 212 can still fully relieve the pressure in the balance ratio control channel 76, on account of the inertia of the plunger 212, in that the flow gap 208 between the balance ratio control channel 76 and the media main channel 20 still remains open for a short time period, on account of the switching inertia, although the media main channel 20 has already been set into the state without pressure. If desired, said switching inertia can be further assisted by a damping spring 226 (cf. FIG. 13, 14).

With reference to FIGS. 13 and 14, however, the switching inertia of the balance ratio control valve 280 can also be omitted. As in the embodiment shown in FIGS. 1 to 6, a pressure relief channel 206 comprising a release valve 204, e.g. in the form of a check valve, can also be provided. Furthermore, the embodiment of FIGS. 13 and 14 is constructed in a manner corresponding to the embodiment of FIGS. 7 to 12, such that repetitions can be avoided here.

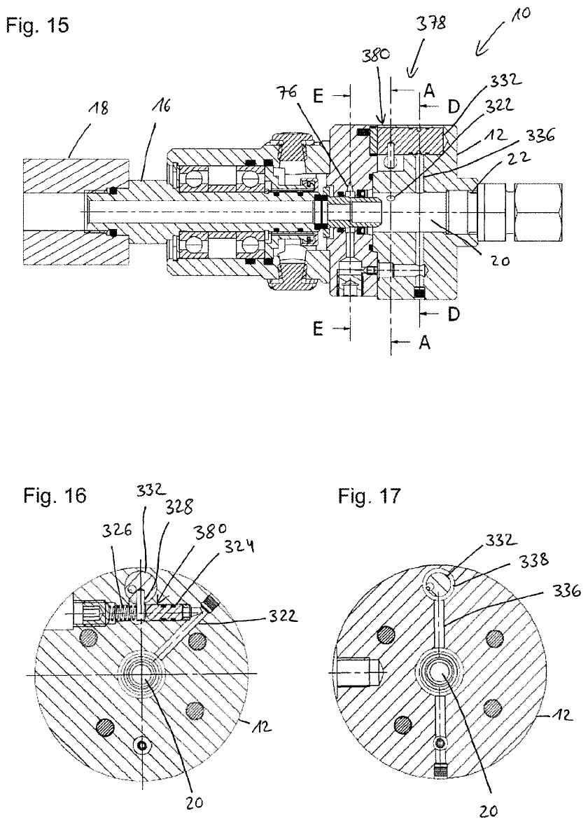

With reference to FIGS. 15 to 28, a balance ratio switching device 378 is shown with a further embodiment of a balance ratio control valve 380, in which the medium does not flow directly past the actuation piston and into the balance ratio control channel 76. Nonetheless, the balance ratio control valve 380 connects the media main channel 20 to the balance ratio control channel 76, but via a further branch channel which branches off from the media main channel 20.

As soon as the media main channel 20 is acted on by CL, cutting oil or hydraulic oil, the respective medium flows into the first branch switching channel 322 of the balance ratio control valve 380. As soon as the pressure in the first branch switching channel 322 exceeds the switching threshold valve p_{U}, a control piston 324 moves to the left, against the spring force of a spring 326. In this case, the control piston 324 rotates about a pin 328 as a lever of a rotatable plunger 332, as far as a stop 334, as a result of which a fluidic connection is released (cf. FIGS. 23 to 28).

A second branch switching channel 336 leads via an annular channel 338 of the rotary piston 332 into an axial control channel 340 in the interior of the rotary piston 332. As soon as the pressure in the media main channel 20 exceeds the switching threshold value p_{U}, and the rotary piston 332 opens the balance ratio control valve 380, the eccentric inner control channel 340 rotates into a position in which the fluidic connection with a channel 342 in a washer 344, and thus a fluidic connection between the media main channel 20 via the second branch switching channel 336, the annular channel 338, the inner control channel 340, and the bore 342 in the washer 344 establishes the fluidic connection to the balance ratio control channel 76 (cf. FIG. 28). As a result, as is also the case in the other embodiments, the larger second effective diameter D1′ is acted on by the medium pressure from the media main channel 20, and as a result the second balance ratio B′ is activated.

As soon as the pressure in the branch switching channel 322 is greater than the switching threshold value p_{U}, then the control piston 324 is pushed, by the medium pressure, counter to the spring force of the spring 326, against the pin 328 which is pressed into the rotary piston 332. The spring 326, by its spring force, causes the rotary piston 332 to rotate into the open position (cf. FIG. 23) only in the case of a medium pressure that is above the switching threshold value p_{U}. When the rotary piston 332 rotates, the pin 328 reaches the stop 334. When the pin 328 strikes the stop 334, the inner control channel 340 of the rotary piston 332 and the bore 342 in the washer 344 are in fluid communication, such that the respective medium can act on the balance ratio control channel 76, with the medium pressure, via the second branch channel 336.

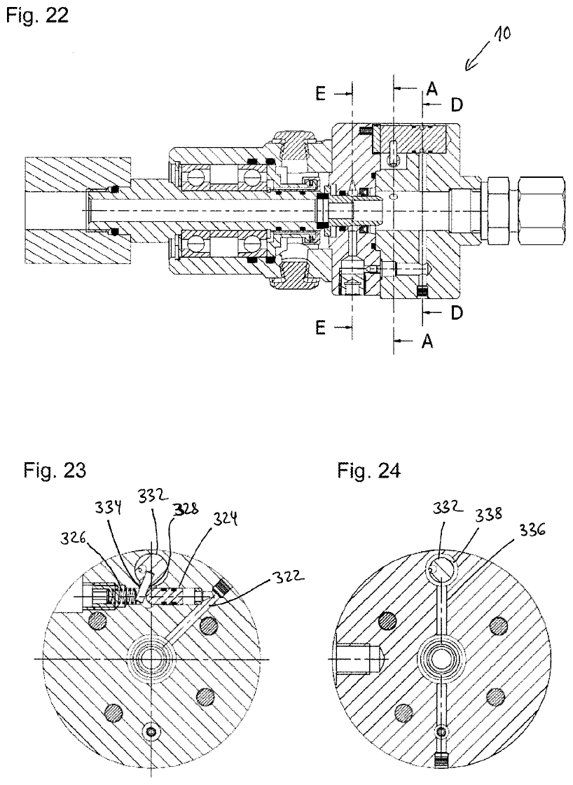

FIGS. 22 to 28 show the actuated, and thus open, state of the balance ratio control valve 380, in which the balance ratio control channel 76 is in fluid communication with the medium pressure from the media channel 20, and is thus pressurized.

In order for the rotary piston 332 to provide sealing relative to the washer 344, in the closed state, the respectively adjoining surfaces can be flat-lapped and be pressed against one another by means of springs 346. The washer 344 is secured against torsion, such that the washer 344 is always at the same angular position.

As soon as the pressurized medium reaches the balance ratio control channel 76, in the actuated, i.e. open, state of the balance ratio control valve 380, this in turn acts on the seal ring carrier 34 or hollow piston 44 at the larger second effective diameter D1′, which corresponds to the higher second balance ratio B′, such that the floating seal ring 38 is pressed against the rotor seal ring 34 with the larger closing force. As a result, the mechanical seal remains closed, even in the case of incompressible media of higher viscosity, and the higher-viscosity medium can flow from the media main channel 20 into the fluid channel 17 of the rotor in a substantially leakage-free manner.

After switching off of the medium, the seal rings 36, 38 are separated again by the Pop-Off® function.

In this embodiment, too, the balance ratio control valve 380 can have a switching inertia, which is brought about by a braked rotation of the rotary piston 332 in the bore 348. As a result of this switching inertia of the balance ratio control valve 380, here too the balance ratio control channel 76 can be completely depressurized.

However, a pressure relief channel 306 comprising a release valve or check valve 304 can be provided in this embodiment too, in order to assist the depressurization of the balance ratio control channel 76. Here, too, the check valve or release valve 304 can have a very low opening pressure, e.g. from 0 bar to 0.04 bar, such that the balance ratio control channel 76 can be set to a state that is virtually completely without pressure. When the balance ratio control channel 76 is activated, pressure equilibrium with the media main channel 20 prevails, as a result of which the setting of the check valve 304 is irrelevant for the function of the rotary union 10.

If compressed air is applied to the media main channel 20, this takes place at a maximum pressure of e.g. 10 bar, such that the switching threshold value ps is not exceeded. As a result, the balance ratio control valve 380 remains closed, and the balance ratio control channel 76 remains in the state without pressure. As a result, the smaller first balance ratio B is established at the mechanical seal 30, which balance ratio B, in the present embodiment, is approximately 0.5 to 0.57. Due to the smaller first balance ratio B, the gap 40 forms, as does a controlled air leakage, which prevents wear at the sealing surfaces. If minimum quantity lubrication (RQL/MQL) is applied to the media main channel 20, this preferably also takes place at a medium pressure below the switching threshold value ps. As a result, the smaller first balance ratio B remains active, which is sufficient for RQL/MQL, in order to allow the RQL/MQL to flow into the fluid channel 17 of the rotor in a substantially leak-free manner.

The embodiments show two different balance ratios B, B′. However, it is also possible to construct a rotary union even having three or more balance ratios.

It is clear for a person skilled in the art that the embodiments described above are to be understood as being by way of example, and the invention is not limited to these, but rather can be varied in a large number of ways, without departing from the scope of protection of the claims. Spatially orienting terms such as front or behind are not to be understood in absolute terms in space, but rather serve to designate the relative relationship of the components, wherein “front” refers to the rotor side, and “behind” or “rear” refers to the axial stator side opposite the rotor. Furthermore, it is clear that, irrespective of whether they are disclosed in the description, the claims, the drawings, or otherwise, the features also define components of the invention that are essential individually, even if they are described together with other features, and the features of the embodiments can be combined with one another. In order to avoid unnecessary repetitions, all the features which are described in connection with one of the embodiments are also considered disclosed in connection with every other embodiment, unless something else is explicitly described.

1. A multimedia-compatible rotary union for transferring fluid media from a stationary machine part into a rotating machine part, in particular suitable both for compressible media and for incompressible media of different viscosities, comprising:
a stationary housing part for installation in the stationary machine part, and comprising a media main channel into which fluid media can be introduced in a pressurized manner,
a rotor for connection to the rotating machine part and having a rotor fluid channel, which is fluidically connected to the media main channel of the stationary housing part,
a mechanical seal between the stationary housing part and the rotor, wherein the mechanical seal comprises a rotor seal ring that rotates together with the rotor, and a stator seal ring, wherein the stator seal ring or the rotor seal ring is fastened to an axially movable seal ring carrier, and wherein the mechanical seal defines a first and a second balance ratio, and
a balance ratio switching device having a predefined switching threshold value for a pressure of a medium, wherein the balance ratio switching device is arranged to switch the mechanical seal from the first balance ratio to the second balance ratio in response to the medium pressure exceeding the switching threshold value.

2. The multimedia-compatible rotary union according to claim 1, wherein the balance ratio switching device is arranged to switch the mechanical seal from the second balance ratio back to the first balance ratio in response to the medium pressure falling below a switch-back threshold value, wherein the switching threshold value and the switch-back threshold value can be the same or different.

3. The multimedia-compatible rotary union according to claim 1, wherein at least one of the switching threshold value and the switch-back threshold value are greater than a maximum permissible operating pressure of the multimedia-compatible rotary union for compressed-air operation.

4. The multimedia-compatible rotary union according to claim 1, wherein the multimedia-compatible rotary union comprises a connection port for connection of a media pressure line, in order to introduce a desired media into the media main channel, the desired media having an associated medium-specific desired medium pressure, and wherein the multimedia-compatible rotary union is arranged such that both compressible media and incompressible media can be introduced into the media main channel, in a pressurized manner, via the connection port.

5. The multimedia-compatible rotary union according to claim 4, wherein the connection port is one of an axial connection port or a radial connection port.

6. The multimedia-compatible rotary union according to claim 1, wherein at least one of:
the first balance ratio of the mechanical seal has a value in the range from approximately 0.40 to 0.65, preferably in the range from approximately 0.45 to 0.60, preferably in the range from approximately 0.47 to 0.60, preferably in the range from approximately 0.50 to approximately 0.57, and
the second balance ratio of the mechanical seal has a value of greater than approximately 0.55, preferably in the range from approximately 0.60 to 1, preferably in the range from approximately 0.60 to 0.7, preferably a value of approximately 0.65+/−0.03.

7. The multimedia-compatible rotary union according to claim 1, wherein the switching threshold value at which the mechanical seal switches from the first to the second balance ratio is greater than 5 bar, preferably greater than 10 bar.

8. The multimedia-compatible rotary union according to claim 1, further comprising a branch switching channel in the stationary housing part that branches off from the media main channel and leads to the balance ratio switching device, and wherein the medium introduced into the media main channel applies the medium pressure to the balance ratio switching device from the media main channel, via the branch switching channel, in order to actuate the balance ratio switching device and to bring about the switching from the first to the second balance ratio.

9. The multimedia-compatible rotary union according to claim 1, wherein the balance ratio switching device comprises a balance ratio control valve configured to control the switching from the first to the second balance ratio.

10. The multimedia-compatible rotary union according to claim 1, wherein the seal ring carrier comprises a first axial region having a first effective diameter, and a second axial region having a second effective diameter, wherein the first effective diameter corresponds to the first balance ratio and the second effective diameter corresponds to the second balance ratio, and further comprising a balance ratio control channel, which leads to the second axial region to which the second effective diameter leads, and wherein the second balance ratio is brought about in that the second effective diameter of the seal ring carrier is acted on with the medium pressure via the balance ratio control channel.

11. The multimedia-compatible rotary union according to claim 10, wherein the balance ratio switching device comprises a balance ratio control valve, and wherein the balance ratio control valve is configured to activate the balance ratio control channel in that the balance ratio control valve opens when the medium pressure present from the media main channel exceeds the switching threshold value, and at least one of:
wherein by opening the balance ratio control valve the medium pressure is guided out of the media main channel, in parallel, into the balance ratio control channel, and
wherein the balance ratio control valve closes when the medium pressure present from the media main channel falls below the switch-back threshold value.

12. The multimedia-compatible rotary union according to claim 10, wherein the balance ratio switching device comprises a balance ratio control valve and wherein the balance ratio control valve opens or closes a fluidic connection from the media main channel to the balance ratio control channel, to the effect that the medium pressure from the media main channel acts on the second effective diameter of the seal ring carrier via the balance ratio control channel when the balance ratio control valve is opened, and/or the medium pressure from the media main channel does not act on the second effective diameter of the seal ring carrier when the balance ratio control valve is closed.

13. The multimedia-compatible rotary union according to claim 10, further comprising a branch switching channel in the stationary housing part that branches off from the media main channel and leads to the balance ratio switching device, wherein the balance ratio switching device comprises a balance ratio control valve, wherein the branch switching channel opens, via the balance ratio control valve, into the balance ratio control channel, and the medium from the media main channel applies the medium pressure to the balance ratio control channel via the branch switching channel and via the balance ratio control valve, when the balance ratio control valve is opened, or wherein the balance ratio control channel branches off from the media main channel and the balance ratio control valve opens the balance ratio control channel when the switching threshold value is exceeded within the stationary housing part, which causes the medium from the media main channel to act on the balance ratio control channel with medium pressure.

14. The multimedia-compatible rotary union according to claim 10, further comprising a branch switching channel in the stationary housing part that branches off from the media main channel and leads to the balance ratio switching device, wherein the balance ratio switching device comprises a balance ratio control valve configured to control the switch from the first to the second balance ratio, wherein the balance ratio control valve is designed as a check valve which opens from the media main channel side and which opens when the switching threshold value is exceeded in the branch switching channel and conducts the medium through, out of the branch switching channel and into the balance ratio control channel, in a pressurized manner, and/or which closes again when the switching threshold value in the branch switching channel is not met, or wherein the balance ratio control valve comprises a plunger which is spring-loaded counter to the medium pressure in the branch switching channel, which plunger forms a seal in a complementary bore of the stationary housing part below the switching threshold value, and is axially displaced when the switching threshold value is exceeded, and releases a fluidic connection between the branch switching channel and the balance ratio control channel, in the form of a gap between the plunger and the complimentary bore, wherein the balance ratio control valve opens when the switching threshold value is exceeded in the branch switching channel, and in the process establishes a fluidic connection between the media main channel and the balance ratio control channel, and which closes when the switch-back threshold value is not met in the branch switching channel, wherein the balance ratio control valve in particular comprises a rotatable plunger.

15. The multimedia-compatible rotary union according to claim 10, wherein the balance ratio switching device comprises a balance ratio control valve, wherein the balance ratio control valve has a switching inertia such that, upon depressurization of the media main channel, at least one of:
the balance ratio control valve closes so slowly that the balance ratio control channel still has sufficient time, during the closing, to relieve pressure via the balance ratio control valve, and
a pressure relief channel, having a release valve that blocks from the media main channel side, leads from the balance ratio control channel to the media main channel, via which the balance ratio control channel relieves pressure, when the media main channel is set so as to be without pressure.

16. A multimedia-compatible rotary union according to any claim 1, wherein the seal ring carrier is sealed by means of a secondary seal in the stationary housing part, and the secondary seal comprises at least one of a first secondary sealing ring comprising a quad ring and second secondary sealing ring comprising an elastomer ring having a U-shaped cross section, which are configured on axially opposing sides of the balance ratio control channel, on the seal ring carrier.

17. A method for operating a multimedia-compatible rotary union according to claim 1, comprising the steps of:
connecting an external compressed gas source to a connection port of the multimedia-compatible rotary union via an external compressed gas supply line and an external distributor,
connecting an external media reservoir containing a medium, comprising at least one of an oil, in particular one of a cutting oil, a hydraulic oil having a viscosity of greater than or equal to 6 mm²/s, or a cooling lubricant, via an external liquid medium pressure supply line, and the external distributor is connected to the connection port of the multimedia-compatible rotary union,
introducing, in a first time interval, a compressed gas of a low pressure via the compressed gas supply line and the connection port into the media main channel, as the medium, in particular at a pressure of less than or equal to 10 bar, and the first balance ratio is established at the mechanical seal and the multimedia-compatible rotary union rotates with the compressed gas and the first balance ratio, and
subsequently switching off the compressed gas,
in a second time interval, introducing the medium, via the liquid medium pressure supply line and the connection port into the media main channel, and,
establishing the second balance ratio at the mechanical seal due to a medium pressure present in the media main channel,
rotating the rotary union with the medium and the second balance ratio, and
later switching off the medium.

18. The method according to claim 17, further comprising the step of, in a third time interval, operating the rotary union without the medium, in dry running operation, and holding open the mechanical seal by the secondary seal.
